(19) United States
(12) Patent Application Publication
(10) Pub. No.: US 2025/0030075 A1
(43) Pub. Date: Jan. 23, 2025

(54) METHOD FOR RECOVERING VALUABLE METAL FROM WASTE BATTERY MATERIAL AND WASTE CATHODE ACTIVE MATERIALS

(71) Applicant: ECOPRO MATERIALS CO., LTD., Pohang (KR)

(72) Inventors: Dong Hee KIM, Pohang-si (KR); Dong Min SHIN, Pohang-si (KR); Dong Ho KANG, Daegu (KR); Hyeok Joon JUN, Pohang (KR)

(73) Assignee: ECOPRO MATERIALS CO., LTD., Pohang (KR)

(21) Appl. No.: 18/508,382

(22) Filed: Nov. 14, 2023

(30) Foreign Application Priority Data
Jul. 18, 2023 (KR) 10-2023-0092787

(51) Int. Cl. H01M 10/54; C22B 1/00; C22B 3/00; C22B 3/22; C22B 7/00; C22B 26/12; C22B 47/00

(52) U.S. Cl. CPC H01M 10/54; C22B 1/005; C22B 3/22; C22B 7/007; C22B 23/0415; C22B 23/0453; C22B 26/12; C22B 47/00

(57) ABSTRACT

A present disclosure provides a method for recovering a valuable metal from a waste battery material and a waste cathode active materials which can reduce wastewater and the cost of processing wastewater by replacing a first aqueous lithium solution including an alkaline substance produced in the process of recovering a valuable metal from a waste battery material and a waste cathode active materials by a pH adjuster.

### CROSS-REFERENCE TO RELATED APPLICATIONS

A claim for priority under 35 U.S.C. § 119 is made to Korean Patent Application No. 10-2023-0092787 filed on Jul. 18, 2023 in the Korean Intellectual Property Office, the entire contents of which are hereby incorporated by reference.

### BACKGROUND

Recent developments in information and communication industry enable compact, lightweight, thin, and portable electronic devices, and thus high energy densification of batteries used as power supplies of such electronic devices are increasingly demanded. A lithium secondary battery may be a most suitable one to satisfy such demands, and thus studies on the lithium secondary battery are being actively carried out. The lithium secondary battery includes a cathode, an anode, electrolyte, and a separator that provides a moving path of lithium ions between the cathode and the anode, and generates electrical energy by the oxidation-reduction reaction of lithium ions in the cathode and the anode.

With the increasing demand of the lithium secondary battery, the amount of waste lithium ion batteries that have reached the end of their lifespan (hereinafter referred to as “waste batteries”) are also increasing. However, since useful materials such as valuable metals are included in the waste battery, the technical development of recovering the valuable metals from the waste battery has been demanded. Here, the valuable metals may include nickel, cobalt, and lithium.

To recover the valuable metals from the waste battery, the waste battery may be discharged, crushed, grinded, and sorted, and may be manufactured into a waste battery material in a powder form in which a cathode active materials (e.g., LiCoO₂, LiMnO₂, Li(NiₓCo_{y}Al_{z})O₂, etc.) and an anode material (e.g., graphite) are mixed.

Meanwhile, a waste cathode active materials may be produced in the manufacture process of the lithium ion secondary battery. The waste cathode active materials does not include grinded materials of an anode material, a cathode current collector, and an anode current collector, but includes lithium (Li) of about 6 to 7%.

Generally, hydrometallurgy is one of methods for recovering valuable metals from a raw material including a waste battery material and a waste cathode active materials. According to the hydrometallurgy, the valuable metals are recovered from the lithium ion secondary battery by dissolving the waste battery material and a waste cathode active materials, removing impurities, extracting solvent, and concentration/crystallization.

However, in the case of recovering valuable metals with the hydrometallurgy, there are problems that the recovery rate of lithium is not good, and the environmental problems occur such as ecotoxicity due to discharge of wastewater.

### PRIOR ART LITERATURE

(Patent Document 1) Republic of Korea Patent Registration No. 10-1682217 (published on Nov. 28, 2016)

### SUMMARY

To solve the technical problem, the present disclosure provides a method for recovering a valuable metal from a waste battery material and a waste cathode active materials which can reduce wastewater and the cost of processing wastewater by replacing a first aqueous lithium solution including an alkaline substance produced in the process of recovering a valuable metal from a waste battery material and a waste cathode active materials by a pH adjuster.

Technical problems of the inventive concept are not limited to the technical problems mentioned above, and other technical problems not mentioned will be clearly understood by those skilled in the art from the following description.

According to an embodiment, a method for recovering a valuable metal from a waste battery material and a waste cathode active materials may include a reduction and heat treatment step comprising adding a reducing agent to a raw material including the waste battery material and the waste cathode active materials and heat-treating the raw material to obtain a lithium compound; a water washing step comprising adding water to the heat-treated raw material to obtain a first aqueous lithium solution in which the lithium compound is dissolved and a water washing residue not dissolved in the water; an acid washing step comprising performing a solid-liquid separation with the first aqueous lithium solution and the water washing residue, and adding an acidic solubilizer to the water washing residue to obtain an acid solution in which the valuable metals including lithium, nickel, cobalt, and manganese are dissolved and an acid washing residue not dissolved in the acidic solubilizer; and a valuable metal precipitation step comprising performing a solid-liquid separation with the acid solution and the acid washing residue, and adding a pH adjuster to increase pH to the acid solution to obtain a precipitation residue in which nickel, cobalt, and manganese are precipitated and a second aqueous lithium solution in which lithium remains, wherein the first aqueous lithium solution recovered in the acid washing step is used for the pH adjuster.

Furthermore, the reducing agent added in the reduction and heat treatment step may include sodium, a sodium compound may be further obtained after the heat treatment in the reduction and heat treatment step, and the sodium compound may be further dissolved in the first aqueous lithium solution.

Furthermore, the water may be added to the heat-treated raw material with a solid-liquid ratio of 1:1 to 1:30 in the water washing step.

Furthermore, the water washing step may be performed for 30 to 240 minutes in a temperature range of 5 to 90° C.

Furthermore, the acidic solubilizer may include at least one of an inorganic acid or an organic acid.

Furthermore, the inorganic acid may include at least one of sulfuric acid, hydrochloric acid, or nitric acid, and the organic acid may include at least one of oxalic acid, citric acid, or malic acid.

Furthermore, the acid washing step may be performed for 30 to 240 minutes in a temperature range of 5 to 90° C.

Furthermore, the acidic solubilizer may be added to the water washing residue with a ratio of 1:1 to 1:10 in the acid washing step.

Furthermore, the pH adjuster may be added until pH of the acid solution is adjusted in a range of 8 to 11 in the valuable metal precipitation step.

Furthermore, the valuable metal precipitation step may be performed for 30 to 600 minutes in a temperature range of 5 to 90° C.

Other detailed matters according to an embodiment of the inventive concept are included in the detailed description and drawings.

### BRIEF DESCRIPTION OF THE FIGURES

FIG. 1 is a flowchart illustrating a method for recovering a valuable metal from a waste battery material and a waste cathode active materials according to an embodiment of the present disclosure.

FIG. 2 is a graph illustrating the Na salt generation according to the pH adjuster adding type and concentration and the lithium concentration of the second aqueous lithium solution after precipitation.

FIG. 3 is a graph illustrating the behavior of the valuable metal of the waste battery material according to the water washing step and the acid washing step.

FIGS. 4 and 5 are graphs illustrating the XRD diffraction analysis of the valuable metal of the waste battery material according to the water washing step, the acid washing step, and the valuable metal precipitation step.

### DETAILED DESCRIPTION

Advantages and features of the inventive concept and methods for achieving them will be apparent with reference to embodiments described below in detail in conjunction with the accompanying drawings. However, the inventive concept is not limited to the embodiments disclosed below, but can be implemented in various forms, and these embodiments are to make the disclosure of the inventive concept complete, and are provided so that this disclosure will be thorough and complete and will fully convey the scope of the invention to those of ordinary skill in the art, which is to be defined only by the scope of the claims.

The terminology used herein is for the purpose of describing particular embodiments only and is not intended to be limiting of the inventive concept. The singular expressions include plural expressions unless the context clearly dictates otherwise. In this specification, the terms “comprises” and/or “comprising” are intended to specify the presence of stated elements, but do not preclude the presence or addition of elements. Like reference numerals refer to like elements throughout the specification, and “and/or” includes each and all combinations of one or more of the mentioned elements. Although “first”, “second”, and the like are used to describe various components, these components are of course not limited by these terms. These terms are only used to distinguish one component from another. Thus, a first element discussed below could be termed a second element without departing from the teachings of the inventive concept.

Unless otherwise defined, all terms (including technical and scientific terms) used herein have the same meaning as commonly understood by one of ordinary skill in the art to which this invention belongs. It will be further understood that terms such as those defined in commonly used dictionaries, will not be interpreted in an idealized or overly formal sense unless expressly so defined herein.

Hereinafter, embodiments of the present disclosure will be described with reference to the accompanying drawings.

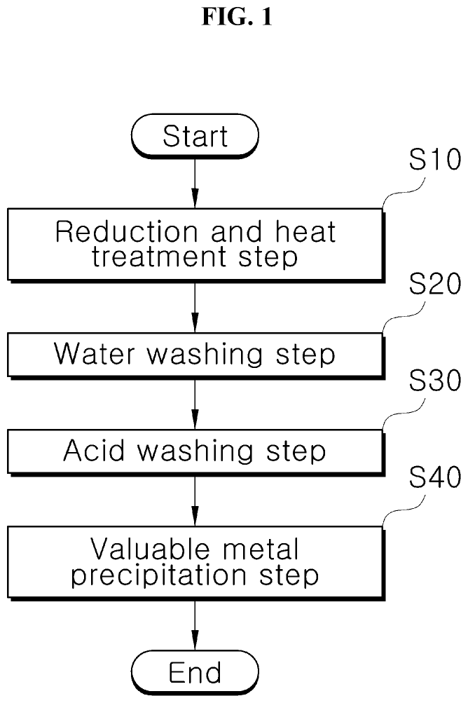

FIG. 1 is a flowchart illustrating a method for recovering a valuable metal from a waste battery material and a waste cathode active materials according to an embodiment of the present disclosure.

As shown in FIG. 1, the method for recovering a valuable metal from a waste battery material and a waste cathode active materials according to an embodiment of the present disclosure may include a reduction and heat treatment step (S10), a water washing step (S20), an acid washing step (S30), and a valuable metal precipitation step (S40).

In the reduction and heat treatment step (S10), a reducing agent may be added to a raw material including the waste battery material and the waste cathode active materials, and the raw material may be heat-treated to obtain a lithium compound. For example, the lithium compound may include Li₂CO₃ and 2Li₂O.

In one example, the waste battery material used in the reduction and heat treatment step (S10) may be a waste battery which is discharged, crushed, grinded, and sorted, and manufactured into the waste battery material in a powder form. The waste battery material may include lithium of 3% to 4%, a binder, and electrolyte. Depending on a type of the waste battery, the binder and the electrolyte may not be included.

In one example, the waste cathode active materials used in the reduction and heat treatment step (S10) may be generated due to a poor manufacturing process of the cathode active materials. The waste cathode active materials may not include grinded materials of an anode material, a cathode current collector, and an anode current collector, but may include lithium (Li) of about 6% to 7%, aluminum, and a binder. Aluminum and the binder may not be included depending on a type of the waste cathode active materials. Furthermore, the raw material including the waste battery material and the waste cathode active materials may include lithium, nickel, cobalt, and manganese in the form of cathode oxide form. For example, the cathode oxide may include at least one of lithium cobalt oxide (LiCoO₂), lithium nickel cobalt manganese oxide (LiNiCoMnO₂), or lithium manganese oxide (LiMnO₂).

In one example, in the reduction and heat treatment step (S10), carbon dioxide may be generated by the reaction between the binder, the anode material, and the organic material contained in the raw material and oxygen or the combustion of oxygen, and the reduction reaction occurs between the carbon dioxide and the cathode oxide contained in the raw material, and thus, the lithium compound may be obtained. In this case, the reduction reaction occurs between the carbon dioxide and the cathode oxide contained in the raw material may be defined by Reaction formula 1.

4LiMeO₂+C→2Li₂O+CO2+4MeO

Li₂O+CO₂→Li₂CO₃ [Reaction formula 1]

Herein, Me may be any one of Ni, Co, and Mn.

In one example, the reducing agent added in the reduction and heat treatment step (S10) may contain sodium. In this case, a sodium compound may be further obtained after the heat treatment of the raw material in the reduction and heat treatment step (S10). For example, the sodium compound may include Na₂O, NaO₂, and Na₂O. The sodium compound may be dissolved in the water added in the heat-treated raw material in the water washing step (S20) that will be described below.

In the water washing step (S20), water is added to the heat-treated raw material to obtain a first aqueous lithium solution in which the lithium compound is dissolved and a water washing residue not dissolved in the water. In this case, the dissolution rate of the lithium compound with respect to the water may be proportional to the amount of the lithium compound obtained in the reduction and heat treatment step (S10). However, as the amount of Li₂CO₃ hardly dissolved in the water in the lithium compound obtained in the reduction and heat treatment step (S10) increases, the dissolution rate of the lithium compound with respect to the water may be strongly influenced by the water which is added. Later, the first aqueous lithium solution recovered by the solid-liquid separation in the acid washing step (S30) to be described below may be replaced and used by a pH adjuster in the valuable metal precipitation step (S40) to be described below as an alkaline substance like Li₂CO₃ is contained in the first aqueous lithium solution.

In one example, the reducing agent added in the reduction and heat treatment step (S10) may contain sodium, and the sodium compound may be formed in the heat treatment process of the reducing agent containing sodium and the raw material. For example, the sodium compound may include Na₂O, NaO₂, and Na₂O. Thereafter, the sodium compound may be further dissolved in the first aqueous lithium solution in the water washing step (S20), in the sodium compound, Na₂O may be dissolved in the water, and NaOH may be generated. In this case, the dissolution reaction of Na₂O and the water may be defined by Reaction formula 2.

Na₂O+H₂O→2NaOH [Reaction formula 2]

Thereafter, the lithium compound and the sodium compound may be dissolved in the first aqueous lithium solution recovered by the solid-liquid separation in the acid washing step (S30) to be described below. As the alkaline substance such as Li₂CO₃ and NaOH is contained in the first aqueous lithium solution, the first aqueous lithium solution may be replaced and used by the pH adjuster in the valuable metal precipitation step (S40) to be described below, and the pH adjustment efficiency may be improved.

In one example, in the water washing step (S20), the water may be added to the heat-treated raw material with a solid-liquid ratio of 1:1 to 1:30. In this case, considering that the dissolution rate of the lithium compound with respect to the water increases as the proportion of the water increases but the concentration of NaOH generated by the dissolution reaction of Na₂O and the water decreases, and the movement and the filtration of the water washing residue becomes difficult as the proportion of the water decreases, it may be preferable that the water may be added to the heat-treated raw material with a solid-liquid ratio of 1:2 to 1:5 in the water washing step (S20).

In one example, the water washing step (S20) may be performed for 30 to 240 minutes in a temperature range of 5 to 90° C. More preferably, the water washing step (S20) may be performed for 60 to 120 minutes in a temperature range of 5 to 90° C. The applicant drives the numerical values for temperature and time of the water washing step (S20) throughout various experiences and experiments as described above, but the present disclosure is not limited thereto.

The acid washing step (S30) may include performing a solid-liquid separation with the first aqueous lithium solution and the water washing residue, and then, adding an acidic solubilizer to the water washing residue to obtain an acid solution in which the valuable metals including lithium, nickel, cobalt, and manganese are dissolved and an acid washing residue not dissolved in the acidic solubilizer. In the acid washing step (S30), the first aqueous lithium solution may be recovered by the solid-liquid separation between the first aqueous lithium solution and the water washing residue.

In one example, the acidic solubilizer may include at least one of an inorganic acid or an organic acid. That is, either one of the inorganic acid or the organic acid may be solely used, or a mixture of the inorganic acid and the organic acid may be used for the acidic solubilizer. Here, the inorganic acid may include at least one of sulfuric acid, hydrochloric acid, or nitric acid, and the organic acid may include at least one of oxalic acid, citric acid, or malic acid. In addition, the inorganic acid may be added with 1 wt % to 50 wt %, and the organic acid may be added with 1 wt % to 80 wt %. More preferably, the inorganic acid may be added with 5 wt % to 20 wt %, and the organic acid may be added with 10 wt % to 40 wt %.

In one example, in the acid washing step (S30), the acidic solubilizer may be added to the water washing residue with a ratio of 1:1 to 1:10. In this case, the dissolution rate of lithium with respect to the acidic solubilizer may be in proportion to an amount of input of the acidic solubilizer, but the valuable metals such as nickel or cobalt may be dissolved together in the acidic solubilizer. However, as the amount of the dissolved nickel and cobalt increases in addition to lithium in the acidic solubilizer, an input amount of the pH adjuster for pH adjustment and precipitation in the valuable metal precipitation step (S40) to be described below may increase, and accordingly, the generation of sodium sulfate, which is waste material, may also increase. Therefore, in the acid washing step (S30), it is preferable that the acidic solubilizer is added to the water washing residue with the solid-liquid ratio described above.

In one example, the acid washing step (S30) may be performed for 30 to 240 minutes in a temperature range of 5 to 90° C. More preferably, the acid washing step (S30) may be performed for 60 to 120 minutes in a temperature range of 5 to 90° C. The applicant drives the numerical values for temperature and time of the acid washing step (S30) throughout various experiences and experiments as described above, but the present disclosure is not limited thereto.

The valuable metal precipitation step (S40) may include performing a solid-liquid separation with the acid solution and the acid washing residue, and then, adding the pH adjuster to increase pH to the acid solution to obtain a precipitation residue in which nickel, cobalt, and manganese are precipitated and a second aqueous lithium solution in which lithium remains. Thereafter, as occasion demands, a solid-liquid separation is performed with the precipitation residue and the second aqueous lithium solution, and the precipitation residue and the second aqueous lithium solution may be separated and recovered.

The pH adjuster added in the valuable metal precipitation step (S40) may use the first aqueous lithium solution recovered in the acid washing step (S30). Accordingly, the first aqueous lithium solution in which the lithium compound, which is recovered in the acid washing step (S30), is dissolved is replaced by the pH adjuster in the valuable metal precipitation step (S40), and an inflow of Na ions or Ca ions, which are generated by adding the pH adjuster used in the conventional process of precipitating valuable metals is prevented, thereby reducing waste water generation and the expense for processing waste water.

In one example, a lithium compound Li₂CO₃ may be dissolved in the first aqueous lithium solution. In another example, in the case that the reducing agent containing sodium is added in the reduction and heat treatment step (S10), a lithium compound Li₂CO₃ and a sodium compound NaOH may be dissolved in the first aqueous lithium solution. The precipitation reaction of the first aqueous lithium solution, nickel, cobalt, and manganese may be defined by Reaction formula 3.

Li₂CO₃+MeSO₄→MeCO₃+Li₂SO₄

2NaOH+MeSO₄→Me(OH)₂+Na₂So₄ [Reaction formula 3]

Herein, Me may be either one of Ni, Co, and Mn.

In one example, in the valuable metal precipitation step (S40), the pH adjuster may be added until pH of the acid solution is adjusted in a range of 8 to 11. More preferably, in the valuable metal precipitation step (S40), the pH adjuster may be added until pH of the acid solution is adjusted in a range of 9 to 10.

In one example, the valuable metal precipitation step (S40) may be performed for 30 to 240 minutes in a temperature range of 5 to 90° C. The applicant drives the numerical values for temperature and time of the valuable metal precipitation step (S40) throughout various experiences and experiments as described above, but the present disclosure is not limited thereto.

In one example, as a solid-liquid separation device, a sedimentation type, a pressure filtration type, a decompression filtration type, a centrifugal dehydration type, and the like may be used, but the present disclosure is not limited thereto.

In one example, after the acid washing step (S30), a first additional washing step may be performed to recover the lithium compound contained in a surface of the precipitation residue. The first additional washing step may include performing a solid-liquid separation with the acid solution and the acid washing residue, and then, washing the acid washing residue with liquid to obtain first wash liquid in which the lithium compound is dissolved in a surface of the acid washing residue.

In one example, after the valuable metal precipitation step (S40), a second additional washing step may be performed to recover the lithium compound contained in a surface of the precipitation residue. The second additional washing step may include performing a solid-liquid separation with the precipitation residue and the second aqueous lithium solution, and then, washing the precipitation residue with liquid to obtain second wash liquid in which the lithium compound is dissolved in the surface of the precipitation residue.

Hereinafter, the step and the output of the step of the present disclosure will be described in detail through experimental examples and XRD analyses.

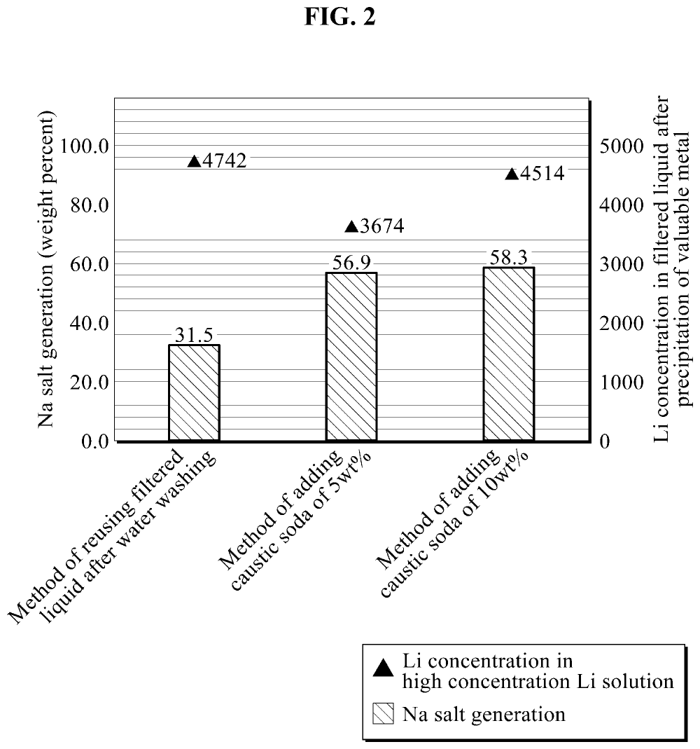

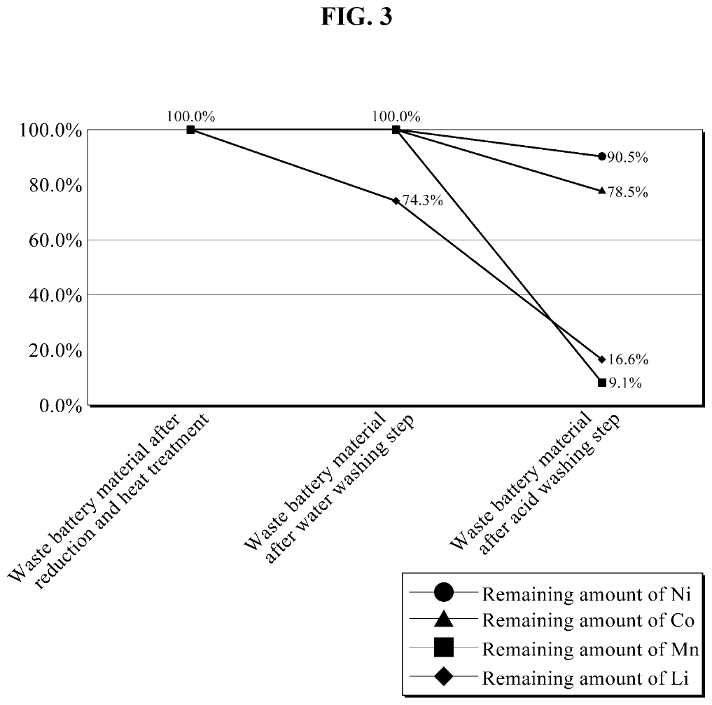

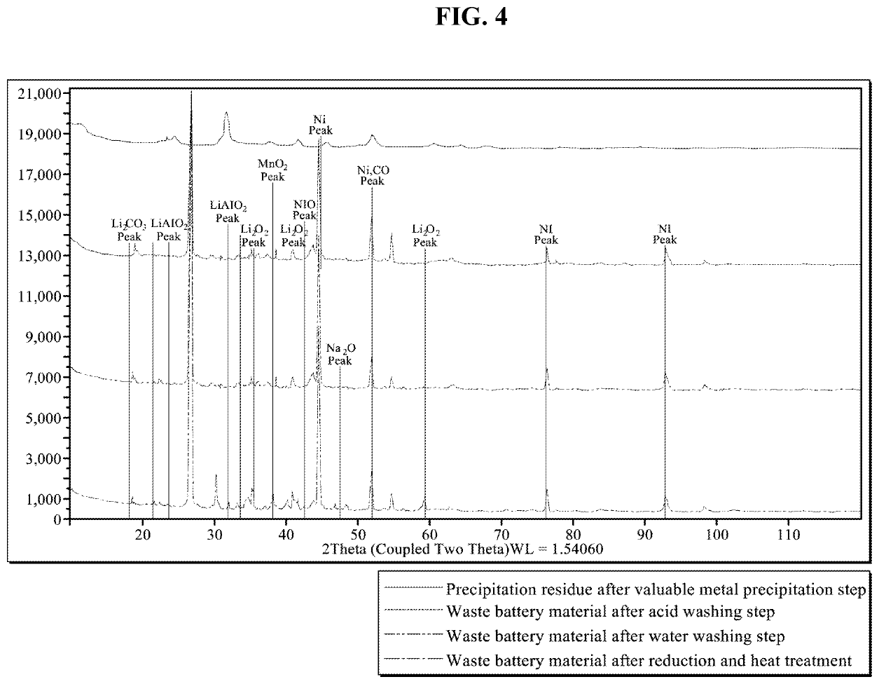

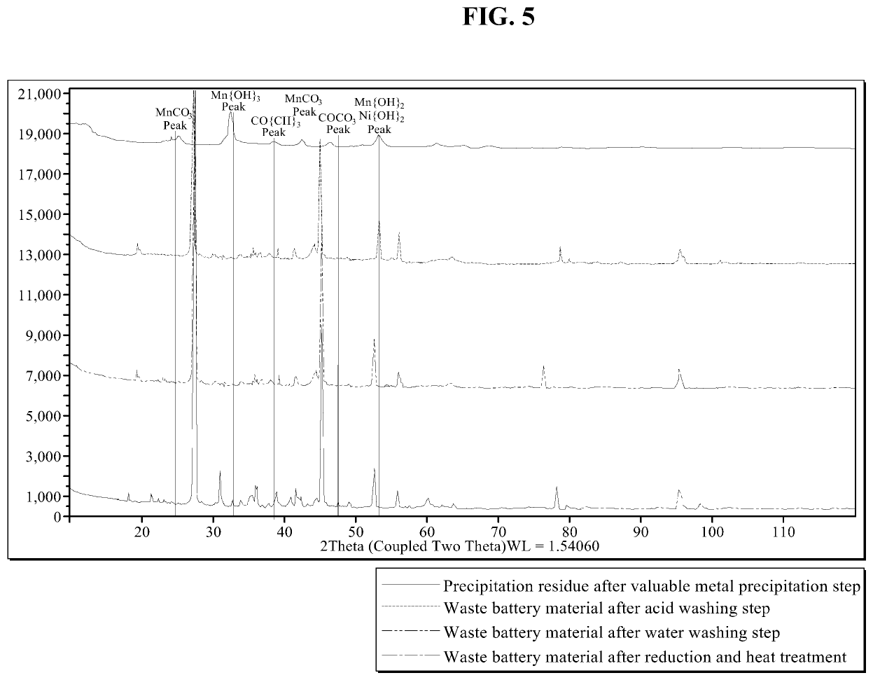

FIG. 2 is a graph illustrating Na salt generation according to the pH adjuster adding type and concentration and the lithium concentration of the second aqueous lithium solution after precipitation, FIG. 3 is a graph illustrating the behavior of the valuable metal of the waste battery material according to the water washing step (S20) and the acid washing step (S30), and FIGS. 4 and 5 are graphs illustrating the XRD diffraction analysis of the valuable metal of the waste battery material according to the water washing step (S20), the acid washing step (S30), and the valuable metal precipitation step (S40). For reference, the filtered liquid shown in FIG. 2 is the second aqueous lithium solution.

### Experimental Example

### 1. Reduction and Heat Treatment Step

In the waste battery material of 100 weight percent, Na₂CO₃, Graphite, and activated carbon, which are reducing agents, are added and heat-treated, and then, the waste battery material of 132 weight percent, which is reduced and heat-treated, is recovered. In this case, 10 to 40 weight percent of the reducing agents are added. Thereafter, to identify the composition of the reduced and heat-treated waste battery material, the result as represented in Table 1 is identified by using an ICP OES analysis equipment.

TABLE 1

| | Ni | Co | Mn | CU | Fe | Zn | Al | Li | Na | S |
|---|---|---|---|---|---|---|---|---|---|---|
| Sample name | wt % | | | ppm | | | | | | |
| Waste battery | 18.66 | 6.18 | 5.65 | 5094 | 3068 | 13 | 32716 | 40893 | 4899 | 1045 |
| material | | | | | | | | | | |
| Waste battery | 13.86 | 4.50 | 4.15 | 3521 | 3127 | 21 | 25884 | 30120 | 79849 | 1598 |
| material after | | | | | | | | | | |
| Reduction and | | | | | | | | | | |
| heat treatment | | | | | | | | | | |

### 2. Water Washing Step

The reduced and heat-treated waste battery material of 132 weight percent and water 397 weight percent are added, and mixed and stirred for 1 hour in a room temperature condition, thereby the water washing step being performed. Thereafter, the slurry is separated with a liquid phase and a solid phase by using the solid-liquid separation device, and the first aqueous lithium solution of 345 weight percent and the water washing residue of 162 weight percent are recovered. Later, the analysis result is identified by using an ICP OES analysis equipment for each sample as represented in Table 2.

Referring to Table 2, it is identified that the lithium compound of the waste battery material which is reduced and heat-treated in the water washing step is dissolved in water. In addition, a large amount of Na ions dissolved in water is identified in the first aqueous lithium solution, and pH of the first aqueous lithium solution measured in the sample is 11.84, which identifies the alkaline substance.

TABLE 2

| | Ni | Co | Mn | CU | Fe | Zn | Al | Li | Na | S |
|---|---|---|---|---|---|---|---|---|---|---|
| Sample name | wt % | | | ppm | | | | | | |
| First aqueous | 0 | 0 | 0 | 0 | 0 | 0 | 116 | 2609 | 23285 | 79 |
| lithium | | | | | | | | | | |
| solution after | | | | | | | | | | |
| water | | | | | | | | | | |
| washing | | | | | | | | | | |
| Water | 15.87 | 5.18 | 4.74 | 4264 | 3247 | 18 | 29897 | 25740 | 21643 | 1409 |
| washing | | | | | | | | | | |
| residue after | | | | | | | | | | |
| water | | | | | | | | | | |
| washing | | | | | | | | | | |

### 3. Acid Washing Step

Sulfuric acid of 10 wt % is added to the water washing residue of 162 weight percent with a ratio of 1:2, and mixed and stirred for 1 hour in a room temperature condition, thereby the acid washing step (S30) being performed. Thereafter, the slurry is separated with a liquid phase and a solid phase into the acid solution and the acid washing residue by using the solid-liquid separation device, and the acid solution of 334 weight percent and the acid washing residue of 157 weight percent are recovered. In this case, to recover the acid and the valuable metal contained in a surface of the acid washing residue, the first additional washing step is performed to recover the first wash liquid of 124 weight percent. Later, the analysis result is identified by using an ICP OES analysis equipment for each sample as represented in Table 3. Referring to Table 3, it is identified the result that the lithium contained in the water washing residue after the water washing is additionally recovered through the acid washing step.

TABLE 3

| Sample | Ni | Co | Mn | CU | Fe | Zn | Al | Li | Na | S |
|---|---|---|---|---|---|---|---|---|---|---|
| name | wt % | | | ppm | | | | | | |
| Acid | 0.46 | 0.36 | 1.35 | 0 | 532 | 0 | 2771 | 6830 | 5146 | 30042 |
| solution after | | | | | | | | | | |
| acid washing | | | | | | | | | | |
| First wash | 0.15 | 0.08 | 0.40 | 0 | 151 | 0 | 342 | 2109 | 2749 | 9033 |
| liquid after | | | | | | | | | | |
| acid washing | | | | | | | | | | |
| Acid | 18.12 | 5.13 | 0.55 | 4382 | 2526 | 15 | 25348 | 5389 | 3842 | 11022 |
| washing | | | | | | | | | | |
| residue after | | | | | | | | | | |
| acid washing | | | | | | | | | | |

### 4. Valuable Metal Precipitation Step

A method for recovering the valuable metal such as nickel, cobalt, and the like from the acid solution after the acid washing includes the precipitation reaction through the pH adjustment of the acid solution. By adding the pH adjuster, pH of the acid solution may be adjusted in a range of about 8 to 9.5.

In this experimental example, the precipitation reaction is progressed in pH 9 for the acid solution of 334 weight percent after the acid washing. In this case, the first aqueous lithium solution recovered by the solid-liquid separation in the acid washing step is used by replacing NaOH and Na₂CO₃, and the precipitation reaction is progressed for about 2 hours in a temperature range of 50 to 60° C. Thereafter, the slurry is separated with a liquid phase and a solid phase by using the solid-liquid separation device, and the second aqueous lithium solution of 515 weight percent after the precipitation reaction and the precipitation residue of 52 weight percent after the precipitation reaction are obtained.

In this case, since the alkaline substance and the remaining lithium are existed on a surface of the precipitation residue, the second additional washing step is performed to recover the alkaline substance and the remaining lithium. In this process, the second wash liquid of 104 weight percent is recovered. Later, the precipitation residue is completely dried, and the precipitation residue of 18 weight percent is identified. The analysis result is identified by using an ICP OES analysis equipment for each sample as represented in Table 4. Referring to Table 4, it is identified the result that all the valuable metal such as nickel, cobalt, and the like contained in the acid solution are recovered in the precipitation residue without adding any separate pH adjuster such as NaOH and Na₂CO₃, and lithium remains in the second aqueous lithium solution.

TABLE 4

| | Ni | Co | Mn | CU | Fe | Zn | Al | Li | Na | S |
|---|---|---|---|---|---|---|---|---|---|---|
| Sample name | wt % | | | ppm | | | | | | |
| Second | 0 | 0 | 0 | 0 | 0 | 0 | 0 | 4742 | 14481 | 18121 |
| aqueous | | | | | | | | | | |
| lithium | | | | | | | | | | |
| solution after | | | | | | | | | | |
| precipitation | | | | | | | | | | |
| reaction | | | | | | | | | | |
| Second wash | 0 | 0 | 0 | 0 | 0 | 0 | 0 | 785 | 2275 | 2424 |
| liquid after | | | | | | | | | | |
| precipitation | | | | | | | | | | |
| reaction | | | | | | | | | | |
| Precipitation | 8.57 | 6.64 | 25.17 | 0 | 9842 | 195 | 51794 | 11839 | 19127 | 22228 |
| residue after | | | | | | | | | | |
| precipitation | | | | | | | | | | |
| reaction | | | | | | | | | | |

Meanwhile, the behavior of the valuable metal of the waste battery material according to the water washing step, the acid washing step, and the valuable metal precipitation step is shown in FIG. 3 to FIG. 5.

### Comparison Example

In the valuable metal precipitation step (S40), NaOH is used as the pH adjuster, and an experiment is performed in the same condition, and this is compared with the first aqueous lithium solution after the water washing. Particularly, the valuable metal such as nickel, cobalt, and the like and lithium are separated by performing the precipitation reaction with the NaOH aqueous solution of 5 wt % and 10 wt % through Comparison evaluation 1 and Comparison evaluation 2.

### Comparison Evaluation 1. Valuable Metal Precipitation Step

The precipitation reaction is performed for the acid solution of 334 weight percent after the acid washing by adding the NaOH aqueous solution of 5 wt %. The reaction is progressed for 2 hours in pH 9 condition, and the reaction temperature is in a range of 50 to 60° C. After the reaction, the slurry is separated with a liquid phase and a solid phase, and the second aqueous lithium solution after the precipitation of 529 weight percent and the precipitation residue of 63 weight percent are recovered. The precipitation residue is washed, and the second wash liquid of 127 weight percent is recovered, and the completely dried weight of the precipitation residue after washing is identified as 19 weight percent. Later, the analysis result is identified by using an ICP OES analysis equipment for each sample as represented in Table 5.

TABLE 5

| | Ni | Co | Mn | CU | Fe | Zn | Al | Li | Na | S |
|---|---|---|---|---|---|---|---|---|---|---|
| Sample name | wt % | | | ppm | | | | | | |
| Second | 0 | 0 | 0 | 0 | 0 | 0 | 0 | 3674 | 16944 | 17414 |
| aqueous | | | | | | | | | | |
| lithium | | | | | | | | | | |
| solution after | | | | | | | | | | |
| precipitation | | | | | | | | | | |
| reaction | | | | | | | | | | |
| Second wash | 0 | 0 | 0 | 0 | 0 | 0 | 0 | 795 | 2140 | 2247 |
| liquid after | | | | | | | | | | |
| precipitation | | | | | | | | | | |
| reaction | | | | | | | | | | |
| Precipitation | 7.76 | 6.10 | 22.87 | 0 | 8672 | 114 | 47150 | 13113 | 19424 | 23815 |
| residue after | | | | | | | | | | |
| precipitation | | | | | | | | | | |
| reaction | | | | | | | | | | |

### Comparison Evaluation 2. Valuable Metal Precipitation Step

The precipitation reaction is performed for the acid solution of 334 weight percent after the acid washing by adding the NaOH aqueous solution of 10 wt %. The reaction is progressed for 2 hours in pH 9 condition, and the reaction temperature is in a range of 50 to 60° C. After the reaction, the slurry is separated with a liquid phase and a solid phase, and the second aqueous lithium solution after the precipitation of 411 weight percent and the precipitation residue of 67 weight percent are recovered. The precipitation residue is washed, and the second wash liquid of 13 weight percent is recovered, and the completely dried weight of the precipitation residue after washing is identified as 19 weight percent. Later, the analysis result is identified by using an ICP QES analysis equipment for each sample as represented in Table 6.

TABLE 6

| | Ni | Co | Mn | CU | Fe | Zn | Al | Li | Na | S |
|---|---|---|---|---|---|---|---|---|---|---|
| Sample name | wt % | | | ppm | | | | | | |
| Second | 0 | 0 | 0 | 0 | 0 | 0 | 0 | 4514 | 22344 | 21814 |
| aqueous | | | | | | | | | | |
| lithium | | | | | | | | | | |
| solution after | | | | | | | | | | |
| precipitation | | | | | | | | | | |
| reaction | | | | | | | | | | |
| Second wash | 0 | 0 | 0 | 0 | 0 | 0 | 0 | 925 | 2340 | 3247 |
| liquid after | | | | | | | | | | |
| precipitation | | | | | | | | | | |
| reaction | | | | | | | | | | |
| Precipitation | 7.85 | 6.08 | 22.43 | 0 | 8672 | 114 | 47150 | 13113 | 23424 | 23815 |
| residue after | | | | | | | | | | |
| precipitation | | | | | | | | | | |
| reaction | | | | | | | | | | |

In the case that NaOH is used for the pH adjuster, Na is added in the pH adjustment process. However, in the case that the pH adjustment of the acid solution is performed by adding the first aqueous lithium solution after the water washing, the pH adjuster such as NaOH is not used. Therefore, since Na ions are not added, the generation of Na salt may be reduced in the waste water processing process, and the efficient process management may be available. According to the method for recovering a valuable metal from a waste battery material and a waste cathode active materials of the present disclosure, there are effects that the first aqueous lithium solution including an alkaline substance produced in the process of recovering a valuable metal from a waste battery material and a waste cathode active materials is replaced by the pH adjuster, and the wastewater generation and the cost of processing wastewater may be reduced.

Effects of the inventive concept are not limited to the effects mentioned above, and other effects not mentioned will be clearly understood by those skilled in the art from the following description.

While the inventive concept has been described with reference to embodiments, it will be apparent to those skilled in the art that various changes and modifications may be made without departing from the spirit and scope of the inventive concept. Therefore, it should be understood that the above embodiments are not limiting, but illustrative.

What is claimed is:

1. A method for recovering a valuable metal from a waste battery material and a waste cathode active materials, the method comprising:
a reduction and heat treatment step comprising adding a reducing agent to a raw material including the waste battery material and the waste cathode active materials and heat-treating the raw material to obtain a lithium compound;
a water washing step comprising adding water to the heat-treated raw material to obtain a first aqueous lithium solution in which the lithium compound is dissolved and a water washing residue not dissolved in the water;
an acid washing step comprising performing a solid-liquid separation with the first aqueous lithium solution and the water washing residue, and adding an acidic solubilizer to the water washing residue to obtain an acid solution in which the valuable metals including lithium, nickel, cobalt, and manganese are dissolved and an acid washing residue not dissolved in the acidic solubilizer; and
a valuable metal precipitation step comprising performing a solid-liquid separation with the acid solution and the acid washing residue, and adding a pH adjuster to increase pH to the acid solution to obtain a precipitation residue in which nickel, cobalt, and manganese are precipitated and a second aqueous lithium solution in which lithium remains,
wherein the first aqueous lithium solution recovered in the acid washing step is used for the pH adjuster.

2. The method of claim 1, wherein the reducing agent added in the reduction and heat treatment step includes sodium,
wherein, a sodium compound is further obtained after the heat treatment in the reduction and heat treatment step, and
wherein the sodium compound is further dissolved in the first aqueous lithium solution.

3. The method of claim 1, wherein the water is added to the heat-treated raw material with a solid-liquid ratio of 1:1 to 1:30 in the water washing step.

4. The method of claim 1, wherein the water washing step is performed for 30 to 240 minutes in a temperature range of 5 to 90° C.

5. The method of claim 1, wherein the acidic solubilizer includes at least one of an inorganic acid or an organic acid.

6. The method of claim 5, wherein the inorganic acid includes at least one of sulfuric acid, hydrochloric acid, or nitric acid, and
wherein the organic acid includes at least one of oxalic acid, citric acid, or malic acid.

7. The method of claim 1, wherein the acid washing step is performed for 30 to 240 minutes in a temperature range of 5 to 90° C.

8. The method of claim 1, wherein the acidic solubilizer is added to the water washing residue with a ratio of 1:1 to 1:10 in the acid washing step.

9. The method of claim 1, wherein the pH adjuster is added until pH of the acid solution is adjusted in a range of 8 to 11 in the valuable metal precipitation step.

10. The method of claim 1, wherein the valuable metal precipitation step is performed for 30 to 600 minutes in a temperature range of 5 to 90° C.
